(19) United States
(12) Patent Application Publication
(10) Pub. No.: US 2012/0228560 A1
(43) Pub. Date: Sep. 13, 2012

(54) CONDUCTIVE ADHESIVE, METHOD FOR MANUFACTURING THE SAME, AND ELECTRONIC DEVICE INCLUDING THE SAME

(75) Inventors: Yong Un Jang, Ulju-gun (KR); Sung Chul Kim, Yeongtong-gu (KR); Yong Cheol Chu, Jung-gu (KR); Seung Jun Jang, Ulju-gun (KR); Yoon Sang Son, Saha-gu (KR); Soon Ho Joeng, Nam-gu (KR)

(73) Assignee: Duk San Tekopia Co., Ltd., Uisan (KR)

(21) Appl. No.: 13/465,738

(22) Filed: May 7, 2012

Related U.S. Application Data
(63) Continuation of application No. PCT/KR2010/001113, filed on Feb. 23, 2010.

(30) Foreign Application Priority Data
Nov. 5, 2009 (KR) 10-2009-0106483

(51) Int. Cl. H01B 1/02; B82Y 30/00

(52) U.S. Cl. 252/514; 252/512; 977/773

(57) ABSTRACT

The present invention relates to a conductive adhesive, a method for manufacturing the same, and an electronic device including the same. The conductive adhesive includes: a conductive particle; a low-melting alloy powder including an alloy including Sn and at least one material selected from the group consisting of Ag, Cu, Bi, Zn, In, and Pb; a nano powder; a first binder including a thermosetting resin; and a second binder including a rosin compound.

### CROSS-REFERENCE TO RELATED APPLICATIONS

This is a continuation application of PCT/KR2010/001113 filed Feb. 23, 2010, which claims the priority to Korean Application No. 10-2009-0106483 filed Nov. 5, 2009, which applications are incorporated herein by reference in their entirety.

### TECHNICAL FIELD

The present invention relates to a conductive adhesive, a method for manufacturing the same, and an electronic device including the same. More particularly, the present invention relates to a conductive adhesive having enhanced electrical conductivity, adhesive force, and low manufacturing cost and to a method for manufacturing the conductive adhesive.

### BACKGROUND ART

A conductive adhesive is widely used for manufacturing various electronic devices. For example, the conductive adhesive may used when a conductive circuit is formed on a printed circuit board, when an electrode or an integrated circuit (IC) chip is formed on a liquid crystal display or a plasma display panel, when a device and an electrode is adhered to a semiconductor device, when an electrode for a solar cell is formed, and so on.

A conductive adhesive in the prior art is manufactured by mixing a conductive powder such as gold (Au), silver (Ag), carbon (C), a binder, an organic solvent, and an additive to have a paste type. Especially, in a field for requiring high conductivity, a gold powder, a silver powder, a palladium powder, or an alloy thereof is generally used. Among them, a conductive paste including the silver powder has good conductivity. Thus, it is used for forming a wiring layer (a conductive layer) of a printed circuit board or an electronic component, or for forming an electric circuit or an electrode of an electronic component. However, ion migration may be induced at the electric circuit or the electrode when the electric field is applied under high temperature and high humidity, and thus, the electrode or the wiring may be short-circuited at unwanted portions. In addition, in order to manufacture a conductive adhesive having good on-resistance, the silver powders are included in the conductive adhesive by 70˜90 wt %. Therefore, by the cost of the silver, the cost of the conductive paste increases also. Particularly, since the adhesive paste is used for various electronic devices, an amount of the silver rapidly increases. Accordingly, a need for reducing a manufacturing cost by replacing the silver powder with the other materials or by reducing the amount of the silver powder increases. Further, the gold powder and the palladium powder conventionally used, besides the silver powder, are expensive. Thus, a need for reducing a manufacturing cost by reducing the amount of the gold and palladium powders increases also.

To achieve this, there is an attempt to use copper as a conductive filler because the copper is much cheaper than the silver. However, when the copper is exposed to air, moisture, high temperature, or other oxides, a copper oxide may be formed, and the conductivity of the conductive adhesive may rapidly decrease.

A conductive adhesive is widely used for manufacturing various electronic devices. For example, the conductive adhesive may used when a conductive circuit is formed on a printed circuit board, when an electrode or an integrated circuit (IC) chip is formed on a liquid crystal display or a plasma display panel, when a device and an electrode is adhered to a semiconductor device, when an electrode for a solar cell is formed, and so on.

A conductive adhesive in the prior art is manufactured by mixing a conductive powder such as gold (Au), silver (Ag), carbon (C), a binder, an organic solvent, and an additive to have a paste type. Especially, in a field for requiring high conductivity, a gold powder, a silver powder, a palladium powder, or an alloy thereof is generally used. Among them, a conductive paste including the silver powder has good conductivity. Thus, it is used for forming a wiring layer (a conductive layer) of a printed circuit board or an electronic component, or for forming an electric circuit or an electrode of an electronic component. However, ion migration may be induced at the electric circuit or the electrode when the electric field is applied under high temperature and high humidity, and thus, the electrode or the wiring may be short-circuited at unwanted portions. In addition, in order to manufacture a conductive adhesive having good on-resistance, the silver powders are included in the conductive adhesive by 70˜90 wt %. Therefore, by the cost of the silver, the cost of the conductive paste increases also. Particularly, since the adhesive paste is used for various electronic devices, an amount of the silver rapidly increases. Accordingly, a need for reducing a manufacturing cost by replacing the silver powder with the other materials or by reducing the amount of the silver powder increases. Further, the gold powder and the palladium powder conventionally used, besides the silver powder, are expensive. Thus, a need for reducing a manufacturing cost by reducing the amount of the gold and palladium powders increases also.

To achieve this, there is an attempt to use copper as a conductive filler because the copper is much cheaper than the silver. However, when the copper is exposed to air, moisture, high temperature, or other oxides, a copper oxide may be formed, and the conductivity of the conductive adhesive may rapidly decrease.

### SUMMARY OF THE DISCLOSURE

The present invention is directed to provide a conductive adhesive having enhanced electrical conductivity and adhesive force and to provide a method for manufacturing the conductive adhesive and an electronic device having the conductive adhesive. Also, the present invention is directed to provide a conductive adhesive having low manufacturing cost, high electrical conductivity, and large adhesive force by replacing an expensive metal powder with a cheap metal powder or by reducing the amount of the expensive metal powder, and to provide a method for manufacturing the conductive adhesive.

The present invention according to an aspect provides a conductive adhesive, including:

a conductive particle;

a low-melting alloy powder including an alloy including Sn and at least one material selected from the group consisting of Ag, Cu, Bi, Zn, In, and Pb;

a nano powder;

a first binder including a thermosetting resin; and

a second binder including a rosin compound.

Here, the first binder may preferably include at least one material selected from the group consisting of an epoxy resin, phenolics, a melamine resin, a urea resin, a polyester or unsaturated polyester resin, silicon, polyurethane, a allyl resin, a thermosetting acrylic resin, a condensation polymerized resin of phenol-melamine, and a condensation polymerized resin of urea-melamine.

Also, the second binder may preferably include at least one material selected from the group consisting of gum rosin, rosin esters, polymerized rosin esters, hydrogenated rosin esters, disproportionated rosin esters, dibasic acid modified rosin esters, phenol modified rosin esters, a terpenephenolic copolymer resin, a maleic anhydride modified resin, and a hydrogenated acrylic modified resin.

In addition, the conductive adhesive may further include a rust inhibitor, and the rust inhibitor may preferably include an amine-based compound or an ammonium-based compound.

Further, the nano powder may preferably include at least one material selected from the group consisting of Ag, Cu, Al, Ni, expanded graphite, carbon nanotube (CNT), carbon, and graphene.

Furthermore, the conductive adhesive may preferably include about 30˜85 wt % of the conductive particle, about 5˜50 wt % of the low-melting alloy powder, and about 3˜13 wt % of the nano powder.

Also, the size of the conductive particle may be preferably the same as or larger than that of the low-melting alloy powder, and the size of the low-melting allow particle may be preferably the same as or larger than that of the nano powder. Selectively, the size of the low-melting allow particle may be preferably the same as or larger than the size of the conductive particle, and the size of the conductive particle may be preferably the same as or larger than that of the nano powder.

In addition, the low-melting alloy powder may preferably include at least one material selected from the group consisting of a Sn—Bi based alloy, a Sn—In based alloy, a Sn—Pb based alloy, or a Sn—Ag—Cu based alloy.

Further, the low-melting alloy powder may preferably have a particle size of about 0.05 μm to about 10 μm.

Furthermore, the conductive particle may preferably include a metal powder.

Yet further, the metal powder may preferably consist of a copper powder.

Yet still further, the conductive particle may preferably include a core, and a coating layer formed on a surface of the core.

Here, the core may preferably include a conductive core, and the conductive core may preferably include at least one material selected from the group consisting of Cu, Ag, Au, Ni, and Al.

Also, the coating layer may preferably include at least one material selected from the group consisting of Cu, Ag, Au, Ni, Al, and solder, and the at least one material may be preferably different from a material of the conductive core.

In addition, the core may preferably include a non-conductive core, and the non-conductive core may preferably include at least one material selected from the group consisting of glass, ceramic, a resin.

Further, the resin may preferably include at least one material selected from the group consisting of polyethylene, polypropylene, polystyrene, compolymer of methylmethacrylate-styrene, copolymer of acrylonitrile-styrene, acrylate, polyvinyl butyral, poly vinyl formal, polyimide, polyamide, polyester, polyvinyl chloride, a fluororesin, a urea resin, a melamine resin, a venzoguanamine resin, a phenol-formalin resin, a phenol resin, a xylene resin, a diarylphthalate resin, an epoxy resin, a polyisocyanate resin, a phenoxy resin, and a silicon resin.

Furthermore, the coating layer may preferably include at least one material selected from the group consisting of Cu, Ag, Au, Ni, Al, and solder.

Yet further, The coating layer may preferably consist of at least one coating layer.

Yet still further, the conductive adhesive further includes an active agent, and the active agent may preferably include at least one material selected from the group consisting of a succinic acid, an adipic acid, a palmitic acid, a 3-boronfluoride ethyl amide complex, butylamine hydrobroimide, butylamine hydrochloride, ethylamine hydrobroimide, pyridine hydrobroimide, cyclohexylamine hydrobroimide, ethylamine hydrochloride, 1,3-diphenyl guanidine hydrobroimide, a 2,2-bishydroxymethyl propionic acid salt, 2,3-dibromo-1-propanol, a lauric acid, and memtetrahydrophthalic anhydride.

The present invention according to another aspect provides a method for manufacturing a conductive adhesive, including:

a step of modifying a thermosetting resin and a rosin compound by adding at least one material selected from the group consisting of hydrogenated cast oil, siloxane-imide, liquid polybutadiene rubber, silica, and acrylate into thermosetting resin and the rosin compound; a step of forming a compound by mixing thermosetting resin and a conductive particle, a low-melting alloy powder, and nano powder, wherein the low-melting alloy powder including Sn, and at least one material selected from the group consisting of Ag, Cu, Bi, Zn, In, and Pb; and a step of dispersing the compound.

Here, the conductive particle may preferably include a coating layer formed by an electroless plating method.

The present invention according to another aspect provides an electronic device, including:

a conductive particle;

a low-melting alloy powder includes Sn and at least one material selected from the group consisting of Ag, Cu, Bi, Zn, In, and Pb;

a nano powder;

a first binder including a thermosetting resin; and

a second binder including a rosin compound.

A conductive adhesive according to the present invention has enhanced electrical conductivity and large adhesive force by dispersing a low-melting alloy powder and a resin between conductive particles.

Also, the conductive particle is formed to have a core-shell structure, and thus, the stability of the core can increase and the cost can decrease.

In addition, in a method for manufacturing the conductive adhesive, by replacing an expensive metal with a cheap metal or a cheap conductive particle of the core-shell structure or by reducing the amount of the expensive metal powder, the manufacturing cost can decrease. Further, an electronic device including the conductive adhesive according to the present invention has a high reliability by using the conductive adhesive having the enhanced electrical conductivity and the large adhesive force.

### BRIEF DESCRIPTION OF DRAWINGS

FIG. 1 is a block diagram illustrating a method for manufacturing a conductive adhesive according to an embodiment of the present invention.

FIG. 2 is a sectional view illustrating a semiconductor device including a conductive adhesive according to an embodiment of the present invention.

### DETAILED DESCRIPTION OF THE DISCLOSURE

Hereinafter, a preferred embodiment of the present invention will be described in detail. The terms of “first” and “second” are used only for discriminate various constituents, and thus the present invention is not limited the above terms. The above terms are used only for distinguish one constituent from the other constituent. The terms of “comprise” and “include” of the present application are only for showing that a character, a step, or a combination thereof described in the specification exists. Thus, the terms of “comprise” and “include” do not exclude any existence or possibility of one or more other characters, steps, or combinations thereof. Unless there are different definitions, all terms used hereto (including technical terms and scientific terms) have the meanings same as those generally understood by the skilled in the art.

A conductive adhesive according to an embodiment of the present invention may include a conductive particle (or conductive particles), a low-melting alloy powder (or low-melting alloy powders), a nano powder (or nano powders), a first binder including a thermosetting resin, and a second binder including a rosin compound.

The conductive particle may be formed of a metal powder, or a core-shell structured particle including a core and a coating layer formed on a surface of the core. For example, a copper (Cu) powder, a silver (Ag) powder, or a gold (Au) powder may be used for the metal powder. Or, a material formed by mixing one or more the copper powder, the silver powder, and the gold powder may be used for the metal powder. In another embodiment, the core is a conductive core, and the conductive core includes at least one material selected from the group consisting of Cu, Ag, Au, Ni, and Al. Also, the coating layer includes at least one material selected from the group consisting of Cu, Ag, Au, Ni, Al, and solder, and the at least one material of the coating layer is different from a material of the conductive core. For example, the copper may be used for the core, and the gold or the silver may be used for the coating layer. In addition, the nickel may be used for the core, and the gold or the silver may be used for the coating layer. A cheap metal may be preferably used.

For the low-melting alloy powder, an alloy powder including Sn and at least one material selected from the group consisting of Ag, Cu, Bi, Zn, In, and Pb may be used. The low-melting alloy powder may have a melting point of about 130˜250° C., preferably, about 138˜220° C., and more preferably, about 138˜180° C.

For example, the Sn/Bi based alloy has a melting point of about 137˜138° C., the Sn/Pb based alloy has a melting point of about 187° C., and the Sn/In based alloy has a melting point of about 148˜155° C. In the present embodiment of the present invention, the Sn/Bi based alloy may be used. Particularly, a Sn42/Bi58 alloy may be preferably used because it is cheap and has a low melting point. Here, the Sn42/Bi58 alloy means an alloy including 42 wt % of Sn and 58 wt % of Bi. Also, the Sn/Ag/Cu based alloy may be preferably used. In addition, a Sn96.5/Ag3.0/Cu0.5 alloy, a Sn98.5/Ag1.0/Cu0.5 alloy, or a Sn99/Ag0.3/Cu0.7 alloy may be preferably used.

For the nano powder, at least one material selected from the group consisting of Ag, Cu, Al, Ni, expanded graphite, carbon nanotube (CNT), carbon, and graphene may be used. In the present invention, the nano powder is a fine powder having a particle size smaller than the conductive particle or the low-melting alloy powder. The nano powder has a particle size of about 10 nm to about 100 nm. Even though the each size of nano powders is slightly different, the size of the most nano powders or the average size of the nano powders can be defined as the particle size of the nano powder.

The conductive particle, the low-melting alloy powder, and the nano powder may have a sphere shape, or a shape of a needle and a flake shape. Even though the conductive particle, the low-melting alloy powder, and the nano powder generally have the sphere shape, when each of them does not have the complete sphere shape, the particle size is defined as an average of the longest and shortest segments of the line penetrating the particles. As the particles are the almost spheres, the particle size becomes close to a diameter of the spheres.

The conductive particle, the low-melting alloy powder, and the nano powder act as fillers. The sizes of the conductive particle, the low-melting alloy powder, and the nano powder are not limited. For example, the size of the conductive particle may be the same as or larger than that of the low-melting alloy powder, and the size of the low-melting allow particle may be the same as or larger than that of the nano powder. Selectively, the size of the low-melting allow particle may be the same as or larger than the size of the conductive particle, and the size of the conductive particle may be the same as or larger than that of the nano powder. It is preferable that the size of the conductive particle is the same as or larger than that of the low-melting alloy powder, and the size of the low-melting allow particle is the same as or larger than that of the nano powder.

Then, the low-melting alloy powder having a size smaller then the conductive particle can be dispersed between the conductive particles, be melted at a low temperature (for example, 138° C.), and be liquefied. The liquefied low-melting alloy powder is soaked into pores between the conductive particles and combines the conductive particles, thereby enhancing the conductivity and the adhesive force.

Also, since the low-melting alloy powder is heat-cured in a little time, it cannot be sufficiently soaked into the pores between the conductive particles. Thus, the nano powder having a size smaller then the conductive particle and the low-melting alloy powder fills the residual pores between the conductive particles. Then, the humidity and the oxygen in the pores can be discharged by the nano powder. Accordingly, the corrosion of the conductive particle and the degradation of the polymer can be suppressed, and thus, the conductivity and the adhesive force can be increased more.

The particle size of the conductive particle may be about 0.05 μm to about 10 μm, and more preferably, about 0.1 μm. When the particle size is below about 0.05 μmm, the dispersibility may be low. When the particle size is above about 10 μm, the porous ratio may increase, contact points between the particles may decrease, and the conductivity may be low. The particle size of the low-melting alloy powder may be about 0.05 μmm to about 10 μn, and more preferably, about 0.1 μm. The particle size of the nano powder may be about 10 nm to about 100 nm, and more preferably, about 50 nm. The particle size of the nano powder is smaller than the particle sizes of the copper powder and the low-melting powder.

A thermosetting resin is used for the first binder. As thermosetting resin, at least one material selected from the group consisting of an epoxy resin, phenolics, a melamine resin, a urea resin, a polyester or unsaturated polyester resin, silicon, polyurethane, an allyl resin, a thermosetting acrylic resin, a condensation polymerized resin of phenol-melamine, and a condensation polymerized resin of urea-melamine may be used. Because the thermosetting resin has a large adhesive force, the gap or the distance between the copper powders can be minimized, and thereby performing an important function in enhancing the conductivity.

The rosin compound is used for the second binder. For the rosin compound, at least one material selected from the group consisting of gum rosin, rosin esters, polymerized rosin esters, hydrogenated rosin esters, disproportionated rosin esters, dibasic acid modified rosin esters, phenol modified rosin esters, a terpenephenolic copolymer resin, a maleic anhydride modified resin, and a hydrogenated acrylic modified resin may be used. The rosin is a natural resin formed by distilling pine resin and has resin acids. That is, the rosin includes an abietic acid as a main material, and includes a neoabietic acid, a levopimaric acid, a hydroabietic acid, a pimaric acid, a dextro-pimaric acid, and so on. The rosin compound is used for a flux by being mixed with an active agent, and actives the soldering of the low-melting alloy powder. Also, the rosin compound enhances wettability.

When the conductive adhesive according to an embodiment of the present invention is coated on a surface to be contacted and is heat-cured, the low-melting alloy powder is melted at a low temperature (for example, about 138˜187° C.), and is liquefied. The liquefied low-melting alloy powder is dispersed into contact surfaces between the conductive particles and pores between the conductive particles. Thereby, a first soldering is performed. And then, by a second soldering through a second curing of thermosetting resin at about 150˜200° C., contraction occurs. As a result, the adhesive property can increase, and can have an adhesive force larger than that of the conventional conductive adhesive. Also, since the low-melting alloy powder is heat-cured in a little time, it may not have sufficient liquidity and the conductivity between the conductive filler may reduced. Thus, in the present embodiment, the nano powder is further included, and the nano powder is dispersed into the conductive particles. As a result, the nano powder fills the pores between the conductive particles and the low-melting alloy powders, and the nano powder acts as a bridge. Thus, the resistance can be minimized and the conductivity can be increased.

On the other hand, a solvent, a curing agent, an active agent, a rest inhibitor, a reducing agent, a thixotropic agent, a thickening agent, etc may be additionally used.

As the solvent, at least one material of clycidyl ethers, glycol ethers, and alpha-terpineol may be used.

As the curing agent, a cycloaliphatic amine curing agent (an epoxy curing agent), an acid anhydride-based curing agent, an amid curing agent, an imidazole curing agent, a latent curing agent, and so on may be used. Particularly, as the latent curing agent, dicyandiamide, 3-(3,4-dichlorophenyl)-1,1-dimethylurea, 2-phenyl-4-methyl-5-hydroxymethylimidazole, an amine adduct-based compound, a dehydride compound, an onium salt (a sulphonium salt, a phosphonium salt, and so on), an active ester of biphenylether block carboxylic acid or polyvalent carboxylic acid may be used. The latent curing agent is a curing accelerator for accelerating the curing of the curing agent. The latent curing agent may be added for reducing the curing temperature, thereby adjusting the curing velocity.

As the active agent, at least one material of a succinic acid, an adipic acid, a palmitic acid, a 3-boronfluoride ethyl amide complex, butylamine hydrobroimide, butylamine hydrochloride, ethylamine hydrobroimide, pyridine hydrobroimide, cyclohexylamine hydrobroimide, ethylamine hydrochloride, 1,3-diphenyl guanidine hydrobroimide, 2,2-bishydroxymethyl propionic acid salt, 2,3-dibromo-1-propanol, a lauric acid, and memtetrahydrophthalic anhydride may be used. The active agent supports the function of the abietic acid and activates the same. The abietic acid that is the main material of the rosin assists the low-melting alloy powder in melting and becoming a liquid. Also, the abietic acid eliminates (cleans) a oxidation film formed at a copper plate of the substrate surface of the electronic device with almost no tolerance, and thus, the low-melting alloy powder can be properly adhered to the substrate surface of the electronic device. When an amount of the first binder and the copper powder besides low-melting alloy powder increases in the conductive adhesive includes, the above function may be hindered. In this case, the active agent supports the function of the abietic acid and activates the same.

As the rust inhibitor, at least one of an amine-based rust inhibitor and an ammonium-based rust inhibitor may be used. The rust inhibitor is slowly evaporated at the temperature of 100° C. or more when the moisture inside the flux, the moisture absorbed during the evaporation of the flux, the humidity of the air, and the humidity and the oxygen between the metal powders are discharged during the heat curing. Therefore, the rust inhibitor removes the humidity and the oxygen. In addition, the corrosion of the metal powder is prevented because a complex compound is formed outside of the metal powder.

As the reducing agent, a hydrazine-based reducing agent or an aldehyde-based reducing agent may be used. The reducing agent reduces the conductive metal when the conductive metal is oxidized, thereby preventing the electrical conductivity from decreasing. The hydrazine-based reducing agent includes hydrazine, hydrazine hydrate, hydrazine sulfate, hydrazine carbonate, and hydrazine hydrochloride.

The aldehyde-based reducing agent includes formaldehyde, acetaldehyde, and propionaldehyde.

The thixotropic agent is for enhancing the printing property. The thixotropic agent improves wetting property, wettability, and thixotropy, thereby, enabling the adhesive being coated smoothly and being hardened quickly. As the thixotropic agent, at least one material selected from the group consisting of hydrogenated cast wax, polyamide wax, polyolefin wax, a dimer acid, a monomer acid, polyester modified polydimethyl siloxane, a polyaminamide carboxylic acid salt, carnauba wax, colloidal silica, and a bentonite-based clay may be used. The thickening agent is a material used for increasing viscosity. As the thickening agent, ethyl cellulose or hydropropyl cellulose may be used. On the other hand, required resistance values of adhesives for low voltage and an adhesive for high voltage are different each other. For example, the adhesive for low voltage is used for bonding a semiconductor chip. Thus, for the adhesive for low voltage, the resistance of about 100˜1000 mΩ is required and the adhesive force is considered important. For the adhesive for high voltage, the resistance less than about 50 mΩ is required and the electrical property is considered important. In order to adjust the resistance, the adhesive force, and the electrical property, the amounts of the conductive particle, the low-melting alloy powder and the nano powder can be properly controlled.

The conductive adhesive according to an embodiment of the present invention may preferably include about 30˜85 wt % of the conductive particle, about 5˜50 wt % of the low-melting alloy powder, and about 3˜13 wt % of the nano powder. An organic compound including the first binder, the second binder, and the additive may be preferably included by about 7˜15 wt %. However, it is just an embodiment, and the present invention is not limited thereto.

In the conductive adhesive according to another embodiment of the present invention, the core of the conductive particle is formed of a conductive core or a non-conductive core. The non-conductive core may include at least one material selected from the group consisting of glass, ceramic, a resin. When the non-conductive core is used, the manufacturing cost can be reduced and the conductive adhesive can have properties equivalent to or superior than those of prior conductive adhesive. For conductive fillers, the conductive particle, the low-melting alloy powder, and the nano powder. In this case, for the resin, polyethylene, polypropylene, polystyrene, compolymer of methylmethacrylate-styrene, copolymer of acrylonitrile-styrene, acrylate, polyvinyl butyral, poly vinyl formal, polyimide, polyamide, polyester, polyvinyl chloride, a fluororesin, a urea resin, a melamine resin, a venzoguanamine resin, a phenol-formalin resin, a phenol resin, a xylene resin, a diarylphthalate resin, an epoxy resin, a polyisocyanate resin, a phenoxy resin, and a silicon resin may be used.

For the coating layer of the conductive particle, the low-melting alloy powder, the first binder, the second binder, and the additive, the similar or same materials described in the above embodiment may be included. The nano powder may be added as needed, or may be not included.

When the non-conductive core is used, the cost can be reduced and can have larger electric force, compared with the conductive core.

In the conductive adhesive according to yet another embodiment of the present invention, plural coating layers are formed on a conductive core. For example, when the resin is used for the core, the coating layer includes a first coating layer of nickel, and a second coating layer of copper on the first coating layer. Selectively, when the resin is used for the core, the coating layer includes a first coating layer of nickel, a second coating layer of copper on the first coating layer, and a third coating layer of solder on the second coating layer.

When the plural coating layers are formed, the conductive particle is more stable. For example, when the resin is used for the core, the first coating layer includes nickel having a high affinity with the resin, and the second coating layer includes copper having a high affinity with the low-melting alloy powder. It is different from the case that the resin is used for the core and only one coating layer of copper is coated. When the only one coating layer is formed, the surface treatment is performed to the resin in order to increase the adhesive property of the resin and the copper.

Also, the first coating layer may include nickel having a high affinity with the resin, the second coating layer may include copper having a high affinity with the low-melting alloy powder. In this case, the third coating layer of solder may be further formed on the second coating layer.

Manufacturing Conductive Adhesive and Property Evaluation

Next, with reference to the following Embodiments and Comparative Examples, the conductive adhesive of the present invention will be described in detail. However, the following Embodiments and Comparative Examples do not limit the present invention.

### Embodiment 1

### Manufacturing of Conductive Adhesive for a Build-Up Stack Substrate of a Cellular Phone

69.58 wt % of a material having molecular weight more than 150 and having a boiling point more than 200° C., among glycidyl ethers or glycol ethers, was used for a solvent. 10.40 wt % of phenol novolac epoxy having epoxy equivalent weight (EEW) of 170˜190(g/eq) was used for a first binder. 5.30 wt % of hydrogenated rosin was used for a second binder. The solvent, the first binder, and the second binder were stirred and dissolved under 100° C. 5 wt % of 3 or 4-methyl-1,2,3,6-tetrahydrophthalic anhydride as an acid anhydride-based curing agent, and 1.15 wt % of dicyandiamide as a latent curing agent were stirred and dissolved at a temperature of more than 80° C. After that, 0.10 wt % of ethylamine hydrobroimide, 0.17 wt % of butylamine hydrochloride, and 3.80 wt % of an adipic acid as active agents were heated at 100° C., and stirred and dissolved. Thus, a flux was manufactured. 1.5 wt % of triethanolamine (TEA) as a stabilizing agent, 0.5 wt % of an azole-based volatile rust inhibitor, and 0.5 wt % of a hydrazine reducing agent were added, were heated at 80° C., and stirred and dissolved. 1.5 wt % of hydrogenated cast wax and 0.5 wt % of polyester modified polydimethyl siloxane as thixotropic and thickening agents were added to adjust viscosity. Thus, a compound was manufactured.

513.33 g of a conductive particle (1˜10 μm) and 220 g of a SnBi powder (1˜10 μm) were mixed with 100 g of the manufactured compound, were stirred and defoamed, and were dispersed at a 3-roll mill (roll gap: less than 5 μm). In the conductive particle, a core was copper, and a coating layer was silver.

### Embodiment 2

### Manufacturing of Conductive Adhesive for a Build-Up Stack Substrate of a Cellular Phone

The conductive adhesive was manufactured by the same method as in Embodiment 1, except that a core was a resin and a coating layer was gold in the conductive particle, and a Sn—In powder was used.

### Embodiment 3

### Manufacturing of Conductive Adhesive for a Build-Up Stack Substrate of a Cellular Phone

The conductive adhesive was manufactured by the same method as in Embodiment 1, except that a core was a resin, a first coating layer was nickel, and a second coating layer was copper in the conductive particle, and a Sn—Pb powder was used.

### Embodiment 4

### Manufacturing of Conductive Adhesive for Bonding an IC Chip

69.58 wt % of a material having molecular weight more than 150 and having a boiling point more than 200° C., among glycidyl ethers or glycol ethers, was used for a solvent. 10.40 wt % of phenol novolac epoxy having epoxy equivalent weight (EEW) of 170˜190(g/eq) was used for a first binder. 5.30 wt % of hydrogenated rosin was used for a second binder. The solvent, the first binder, and the second binder were stirred and dissolved under 100° C. 5 wt % of 3 or 4-methyl-1,2,3,6-tetrahydrophthalic anhydride as an acid anhydride-based curing agent, and 1.15 wt % of dicyandiamide as a latent curing agent were stirred and dissolved at a temperature of more than 80° C. After that, 0.10 wt % of ethylamine hydrobroimide, 0.17 wt % of butylamine hydrochloride, and 3.80 wt % of an adipic acid as active agents were heated at 100° C., and stirred and dissolved. Thus, a flux was manufactured. 1.50 wt % of triethanolamine (TEA) as a stabilizing agent, 0.5 wt % of an azole-based volatile rust inhibitor, and 0.5 wt % of a hydrazine reducing agent were added, were heated at 80° C., and stirred and dissolved. 1.5 wt % of hydrogenated cast wax and 0.5 wt % of polyester modified polydimethyl siloxane as thixotropic and thickening agents were added to adjust viscosity. Thus, a compound was manufactured.

513.33 g of a conductive particle (1˜3 μm) and 220 g of a SnBi powder (1˜5 μm) were mixed with 100 g of the manufactured compound, were stirred and defoamed, and were dispersed at a 3-roll mill (roll gap: less than 5 μm). In the conductive particle, a core was copper, and a coating layer was silver.

### Embodiment 5

### Manufacturing of Conductive Adhesive for Bonding an IC Chip

The conductive adhesive was manufactured by the same method as in Embodiment 4, except that a core was a resin and a coating layer was gold the conductive particle, and a Sn—In powder was used.

### Embodiment 6

### Manufacturing of Conductive Adhesive for Bonding an IC Chip

The conductive adhesive was manufactured by the same method as in Embodiment 4, except that a core was a resin, a first coating layer was nickel, and a second coating layer was copper in the conductive particle, and a Sn—Pb powder was used.

### Embodiment 7

### Manufacturing of Conductive Adhesive for EMI

33.38 wt % of a high-performance epoxy resin having epoxy equivalent weight (EEW) of 190˜220(g/eq) was hydrogenated and dissolved, and 3 wt % of dicyandiamide as a curing agent was modified by 5 wt % of hydrogenated cast wax. They were dissolved under 80° C. with 48.47 wt % of a solvent. A material having molecular weight more than 150 and having a boiling point more than 200° C., among glycidyl ethers or glycol ethers, is used as a solvent. And then, 1.15 wt % of 3-(3,4-dicholrophenyl)-1,1-dimethylurea as a curing accelerator were added, and then, 1.00 wt % of polyoxyethyelene sorbitan monooleate as a dispersing agent was added. After that, they were stirred and dissolved under 80° C. 2.50 wt % of triethanolamine (TEA) as a stabilizing agent, 1.50 wt % of an azole-based volatile rust inhibitor, and 1.00 wt % of a hydrazine reducing agent were added, were heated at 100° C., and stirred and dissolved. 1.50 wt % of polyester modified polydimethyl siloxane and 1.50 wt % of polyester modified polydimethyl siloxane as thixotropic and thickening agents were added to adjust viscosity. Thus, a compound was manufactured.

723.33 g of a conductive particle (1˜3 μm) and 70 g of a silver nano powder (0.1 μm) were mixed with 100 g of the manufactured compound, were stirred and defoamed, and were dispersed at a 3-roll mill (roll gap: less than 5 μm). In the conductive particle, a core was copper, and a coating layer was silver.

### Embodiment 8

### Manufacturing of Conductive Adhesive for EMI

The conductive adhesive was manufactured by the same method as in Embodiment 7, except that a core was a resin and a coating layer was gold in the conductive particle, and a Sn—In powder was used.

### Embodiment 9

### Manufacturing of Conductive Adhesive for EMI

The conductive adhesive was manufactured by the same method as in Embodiment 7, except that a core was a resin, a first coating layer was nickel, and a second coating layer was copper in the conductive particle, and a Sn—Pb powder was used.

### Embodiment 10

### Manufacturing of Conductive Adhesive for Filling a Through Hole

47.68 wt % of a material having molecular weight more than 150 and having a boiling point more than 200° C., among glycidyl ethers or glycol ethers, was used for a solvent. 13.38 wt % of diglycidyl ether of bisphenol-A having epoxy equivalent weight (EEW) of 184˜190(g/eq) was used for a first binder. 10.39 wt % of hydrogenated rosin was used for a second binder. The solvent, the first binder, and the second binder were stirred and dissolved under 100° C. 10.00 wt % of a condensation polymerized resin of phenol-melamine as a third binder and curing agent, 5 wt % of 3 or 4-methyl-1,2,3,6-tetrahydrophthalic anhydride as an acid anhydride-based curing agent, and 1.15 wt % of 2,4,6-tris(dimethylaminomethyl)phenol), which is tertiary amine based curing agent, as a curing accelerator were stirred and dissolved at a temperature under 100° C. After that, 0.15 wt % of ethylamine hydrobroimide, 0.25 wt % of butylamine hydrochloride, and 4.50 wt % of an adipic acid as active agents were heated under 100° C., and stirred and dissolved. Thus, a flux was manufactured. 2.5 wt % of triethanolamine (TEA) as a stabilizing agent, 0.5 wt % of an azole-based volatile rust inhibitor, and 0.5 wt % of a hydrazine reducing agent were added, were heated at 150° C., and were stirred and dissolved. 2.5 wt % of hydrogenated cast wax and 1.5 wt % of polyester modified polydimethyl siloxane as thixotropic and thickening agents were added to adjust viscosity. Thus, a compound was manufactured. 373.33 g of a conductive particle (1-3 μm), 350 g of a SnBi powder (1˜5 μm), and 70 g of a silver nano powder (0.1 μm) as fillers were mixed with 100 g of the manufactured compound, stirred and defoamed, and were dispersed at a 3-roll mill (roll gap: less than 5 μm). In the conductive particle, a core was copper, and a coating layer was silver.

### Embodiment 11

### Manufacturing of Conductive Adhesive for Filling a Through Hole

The conductive adhesive was manufactured by the same method as in Embodiment 10, except that a core was a resin and a coating layer was gold in the conductive particle, and a Sn—In powder was used.

### Embodiment 12

### Manufacturing of Conductive Adhesive for Filling a Through Hole

The conductive adhesive was manufactured by the same method as in Embodiment 10, except that a core was a resin, a first coating layer was nickel, and a second coating layer was copper in the conductive particle, and a Sn—Pb powder was used.

### Embodiment 13

### Manufacturing of Conductive Adhesive for Bonding a IC Chip

69.58 wt % of a material having molecular weight more than 150 and having a boiling point more than 200° C., among glycidyl ethers or glycol ethers, was used for a solvent. 10.40 wt % of phenol novolac epoxy having epoxy equivalent weight (EEW) of 170˜190(g/eq) was used for a first binder. 5.30 wt % of hydrogenated rosin was used for a second binder. The solvent, the first binder, and the second binder were stirred and dissolved under 100° C. 5 wt % of 3 or 4-methyl-1,2,3,6-tetrahydrophthalic anhydride as an acid anhydride-based curing agent, and 1.15 wt % of dicyandiamide as a latent curing agent were stirred and dissolved at a temperature of more than 80° C. After that, 0.10 wt % of ethylamine hydrobroimide, 0.17 wt % of butylamine hydrochloride, and 3.80 wt % of an adipic acid as active agents were heated at 100° C., and stirred and dissolved. Thus, a flux was manufactured. 1.5 wt % of triethanolamine (TEA) as a stabilizing agent, 0.5 wt % of an azole-based volatile rust inhibitor, and 0.5 wt % of a hydrazine reducing agent were added, were heated at 80° C., and were stirred and dissolved. 1.5 wt % of hydrogenated cast wax and 0.5 wt % of polyester modified polydimethyl siloxane as thixotropic and thickening agents were added to adjust viscosity. Thus, a compound was manufactured.

513.33 g of a copper powder (1˜3 μm) and 220 g of a SnBi powder (1˜5 μm) were mixed with 100 g of the manufactured compound, were stirred and defoamed, and were dispersed at a 3-roll mill (roll gap: less than 5 μm). In the conductive particle, a core was copper, and a coating layer was silver.

### Embodiment 14

### Manufacturing of Conductive Adhesive for Filling a Through Hole

47.68 wt % of a material having molecular weight more than 150 and having a boiling point more than 200° C., among glycidyl ethers or glycol ethers, was used for a solvent. 13.38 wt % of diglycidyl ether of bisphenol-A having epoxy equivalent weight (EEW) of 184˜190(g/eq) was used for a first binder. 10.39 wt % of hydrogenated rosin was used for a second binder. The solvent, the first binder, and the second binder were stirred and dissolved under 100° C. 10.00 wt % of a condensation polymerized resin of phenol-melamine as a third binder and curing agent, 5 wt % of 3 or 4-methyl-1,2,3,6-tetrahydrophthalic anhydride as an acid anhydride-based curing agent, and 1.15 wt % of 2,4,6-tris(dimethylaminomethyl)phenol), which is tertiary amine based curing agent, as a curing accelerator were stirred and dissolved at a temperature under 100° C. After that, 0.15 wt % of ethylamine hydrobroimide, 0.25 wt % of butylamine hydrochloride, and 4.50 wt % of an adipic acid as active agents were heated under 100° C., and stirred and dissolved. Thus, a flux was manufactured. 2.5 wt % of triethanolamine (TEA) as a stabilizing agent, 0.5 wt % of an azole-based volatile rust inhibitor, and 0.5 wt % of a hydrazine reducing agent were added, were heated at 150° C., and were stirred and dissolved. 2.5 wt % of hydrogenated cast wax and 1.5 wt % of polyester modified polydimethyl siloxane as thixotropic and thickening agents were added to adjust viscosity. Thus, a compound was manufactured. 373.33 g of a copper powder (1˜3 μm), 350 g of a SnBi powder (1˜5 μm), and 70 g of a silver nano powder (0.1 μm) as fillers were mixed with 100 g of the manufactured compound, were stirred and defoamed, and were dispersed at a 3-roll mill (roll gap: less than 5 μm). In the conductive particle, a core was copper, and a coating layer was silver.

### Embodiment 15

### Manufacturing of Conductive Adhesive for EMI

33.38 wt % of a high-performance epoxy resin having epoxy equivalent weight (EEW) of 190˜220 (g/eq) was modified by 5 wt % of hydrogenated cast wax. They were dissolved under 80° C. with 48.47 wt % of a solvent. A material having molecular weight more than 150 and having a boiling point more than 200° C., among glycidyl ethers or glycol ethers, was used as a solvent. And then, 3 wt % of dicyandiamide as a curing agent and 1.15 wt % of 3-(3,4-dicholrophenyl)-1,1-dimethylurea as a curing accelerator were added, and then, 1.00 wt % of polyoxyethyelene sorbitan monooleate as a dispersing agent was added. After that, they were stirred and dissolved under 80° C. 2.50 wt % of triethanolamine (TEA) as a stabilizing agent, 1.50 wt % of an azole-based volatile rust inhibitor, and 1.00 wt % of a hydrazine reducing agent were added, were heated at 100° C., and were stirred and dissolved. 1.50 wt % of polyester modified polydimethyl siloxane and 1.50 wt % of polyester modified polydimethyl siloxane as a thixotropic and thickening agents were added to adjust viscosity. Thus, a compound was manufactured.

723.33 g of a copper powder (1˜3 μm) and 70 g of a silver nano powder (0.1 μm) as fillers were mixed with 100 g of the manufactured compound, were stirred and defoamed, and were dispersed at a 3-roll mill (roll gap: less than 5 μm).

### Embodiment 16

### Manufacturing of Conductive Adhesive for a Build-Up Stack Substrate of a Cellular Phone

69.58 wt % of a material having molecular weight more than 150 and having a boiling point more than 200° C., among glycidyl ethers or glycol ethers, was used for a solvent. 10.40 wt % of phenol novolac epoxy having epoxy equivalent weight (EEW) of 170˜190(g/eq) was used for a first binder. 5.30 wt % of hydrogenated rosin was used for a second binder. The solvent, the first binder, and the second binder were stirred and dissolved under 100° C. 5 wt % of 3 or 4-methyl-1,2,3,6-tetrahydrophthalic anhydride as an acid anhydride-based curing agent, and 1.15 wt % of dicyandiamide as a latent curing agent were stirred and dissolved at a temperature of more than 80° C. After that, 0.10 wt % of ethylamine hydrobroimide, 0.17 wt % of butylamine hydrochloride, and 3.80 wt % of an adipic acid as active agents were heated at 100° C., and were stirred and dissolved. Thus, a flux was manufactured. 1.50 wt % of triethanolamine (TEA) as a stabilizing agent, 0.5 wt % of an azole-based volatile rust inhibitor, and 0.5 wt % of a hydrazine reducing agent were added, were heated at 80° C., and were stirred and dissolved. 1.5 wt % of hydrogenated cast wax and 0.5 wt % of polyester modified polydimethyl siloxane as thixotropic and thickening agents were added to adjust viscosity. Thus, a compound was manufactured.

A copper powder, a SnBi powder, and a silver nano powder were mixed with the manufactured compound, were stirred and defoamed, and were dispersed at a 3-roll mill (roll gap: less than 5 μm).

### Embodiment 17

### Manufacturing of Conductive Adhesive for a Build-Up Stack Substrate of a Cellular Phone

The conductive adhesive was manufactured by the same method as in Embodiment 16, except that a Sn—In powder was used.

### Comparative Example 1

### Prior Conductive Adhesive

A silver conductive adhesive sold in the market (made by DNP, product name: MS-100) was prepared.

### Comparative Example 2

### Prior Conductive Adhesive

A silver conductive adhesive sold in the market (made by ABLEBOND, product name: 3230) was prepared.

### Comparative Example 3

### Prior Conductive Adhesive

A silver conductive adhesive sold in the market (made by Ablestik, product name: ABLEBOND 8390) was prepared.

### Comparative Example 4

### Prior Conductive Adhesive

A silver conductive adhesive sold in the market (made by Mitsui, product name: MSP-812B) was prepared.

### Experimental Embodiment 1

### Evaluation of Conductive Adhesive (for a Build-Up Stack Substrate of a Cellular Phone)

After coating the adhesive of Comparative Example 1 and the adhesive of Embodiment 1 by a screen mounting apparatus having an opening of 150 μm on a build-up stack substrate of a cellular phone, they were pre-cured for one minute at a temperature of 75° C. by a hardening apparatus. And then, they were coated in the same way five times, and were firstly-cured for 500 seconds (8 minutes and 20 seconds) at a temperature of 65° C. and were secondly-cured for 1000 seconds (16 minutes and 40 seconds) at a temperature of 165° C. After that, viscosity, adhesive strength, sheet resistance, and hardness were measured. In addition, the existence of a resistance change was measured at a thermal cycle (TC) test at low and high temperatures and a temperature-humidity bias (THB) test. Table 1 shows test items and test results. With reference to Table 1, it can be seen that the adhesive of Embodiment 1 satisfied the requirements or had property similar to or equivalent to the requirements in the viscosity, the adhesive strength, the sheet resistance, the hardness, the TC test, and the THB test. Particularly, the adhesive of Embodiment 1 had viscosity and adhesive strength larger than those of the adhesive of Comparative Example 1.

TABLE 1

| | Comparative | | | Measure | |
|---|---|---|---|---|---|
| Items | Example 1 | Embodiment 1 | Requirement | method | Apparatus |
| Viscosity/ | 350 kcps/8.70 | 370 kcps/8.50 | 350 ± | 25° C., 5 rpm (JIS | Brookfield |
| T.I | | | 10 kcps/8.0~9.0 | Z3284) | HBDV2 + pro |
| Adhesive | 32 N/mm² | 38 N/mm² | More than | KS M 3721 | 1605 HTP |
| Strength | | | 30 N/mm² | | (made by |
| | | | | | Aikoh) |
| TC test | No resistance | No | No resistance | −65° C., 30 minutes | T/C |
| | change | resistance | change | [symbol] 10 minutes [symbol] | apparatus |
| | | change | | 150° C., 30 minutes/ | |
| | | | | 1000 times (JIS C0027) | |
| THB test | No resistance | No | No resistance | 85° C./85% 3.6 V | Thermo- |
| | change | resistance | change | 1000 hrs (JIS C0022) | hygrostat |
| | | change | | | |
| Sheet | 0.85 | 1.25 | Less than | 4-terminal sheet | Milliohm |
| Resistance | | | 2.50 | resistance | Meter |
| [10⁻⁴ Ω · cm] | | | | measurement | |
| hardness | 46 HVI | 42 HVI | 30~50 HVI | Advanced frictionless | Vickers |
| | | | | loading shaft | Hardness |
| | | | | mechanism | Tester HVS- |
| | | | | | 50 |
| | | | | | 5-2900 HVI |

With reference to Table 1, it can be seen that the adhesive of Embodiment 1 satisfied the requirements or had property similar to or equivalent to the requirements in the viscosity, the adhesive strength, the sheet resistance, the hardness, the TC test, and the THB test. Particularly, the adhesive of Embodiment 1 had viscosity and adhesive strength larger than those of the adhesive of Comparative Example 1.

### Experimental Embodiment 2

### Evaluation of Conductive Adhesive (for Bonding an IC Chip)

After coating the adhesive of Comparative Example 2 and the adhesive of Embodiment 2 by a dispensing-type mounting apparatus on an IC chip, they were cured by using an oven for 15 minutes at a temperature of 175° C. After that, viscosity, adhesive strength, sheet resistance, and hardness were measured. In addition, the existence of a resistance change was measured at a TC test, a THB test, and so on. Table 2 shows test items and test results. With reference to Table 2, it can be seen that the adhesive of Embodiment 2 satisfied the requirements or had property similar or equivalent to the requirements in the viscosity, the adhesive strength, the sheet resistance, the hardness, the TC test, the THB test, and a thermogravimetric analysis (TGA). Particularly, the adhesive of Embodiment 2 had viscosity and adhesive strength larger than those of the adhesive of Comparative Example 2.

TABLE 2

| | Comparative | | | Measure | |
|---|---|---|---|---|---|
| Items | Example 2 | Embodiment 2 | Requirement | method | Apparatus |
| Viscosity/ | 11 kcps/0.60 | 10 kcps/1.20 | 10 ± | 25° C., 10 rpm (JIS | Brookfield |
| thixo(T.I) | | | 2 kcps/0.50~1.50 | Z3284) | HBDV2 + pro |
| Adhesive | 49 N/mm² | 43 N/mm² | More than | KS M 3721 | 1605 HTP |
| Strength | | | 35 N/mm² | | (made by |
| | | | | | Aikoh) |
| TC test | No resistance | No | No resistance | −65° C., 30 minutes | T/C |
| | change | resistance | change | [symbol] 10 minutes [symbol] | apparatus |
| | | change | | 150° C., 30 minutes/ | |
| | | | | 1000 times (JIS C0027) | |
| THB test | No resistance | No | No resistance | 85° C./85% 3.6 V | Thermo- |
| | change | resistance | change | 1000 hr (JIS C0022) | hygrostat |
| | | change | | | |
| Sheet | 1.8 | 2.5 | Less than 10⁻¹ Ω · cm | 4-terminal sheet | Milliohm |
| Resistance | | | | resistance | Meter |
| [10⁻¹ Ω · cm] | | | | measurement | |
| | | | | (HIOKI 3541) | |
| Hardness | 56 HVI | 45 HVI | More than | Advanced frictionless | Vickers |
| | | | 40HVI | loading shaft | Hardness |
| | | | | mechanism | Tester HVS- |
| | | | | | 50 |
| | | | | | 5-2900 HVI |
| Curing | 185° C./ | 185° C./ | 170° C./ | Heat wind, two-step | Oven |
| Condition | 40 minutes | 40 minutes | 20 minutes | curing (1^{st}: 80° C., 2^{nd}: | |
| | | | | 185° C.) | |

### Experimental Embodiment 3

### Evaluation of Conductive Adhesive (for EMI)

Properties of the conductive adhesive manufactured by Embodiment 7 were evaluated. The viscosity was 400 Kcps (Brookfield, 25° C., 10 PPM), the thixotropic property was 6.8 cp, and the sheet resistance was 850 mΩ. Thus, the conductive adhesive of Embodiment 7 can be used for EMI.

### Experimental Embodiment 4

### Evaluation of Conductive Adhesive (for Bonding an IC Chip)

After coating the adhesive of Comparative Example 3 and the adhesive of Embodiment 13 by a dispensing-type mounting apparatus on an IC chip, they were cured by using an oven for 15 minutes at a temperature of 175° C. After that, viscosity, adhesive strength, sheet resistance, and hardness were measured. In addition, the existence of a resistance change was measured at a TC test, a THB test, and so on. Table 3 shows test items and test results. With reference to Table 3, it can be seen that the adhesive of Embodiment 13 satisfied the requirements or had property similar or equivalent to the requirements in the viscosity, the adhesive strength, the sheet resistance, the hardness, the TC test, and the THB test. Particularly, the adhesive of Embodiment 13 had viscosity and adhesive strength larger than those of the adhesive of Comparative Example 3.

TABLE 3

| | Comparative | Embodiment | | Measure | |
|---|---|---|---|---|---|
| Items | Example 3 | 13 | Requirement | method | Apparatus |
| Viscosity/ | 55 kcps/0.55 | 6.5 kcps/0.60 | 60 ± | 25° C., 5 rpm (JIS | Brookfield |
| T.I | | | 10 kcps/0.5~0.6 | Z3284) | HBDV2 + pro |
| Adhesive | 25 N/mm² | 38 N/mm² | 20 N/mm² | KS M 3721 | 1605 HTP |
| Strength | | | | | (made by |
| | | | | | Aikoh) |
| TC test | No resistance | No | No resistance | −65° C., 30 minutes | T/C |
| | change | resistance | change | [symbol] 10 minutes [symbol] | apparatus |
| | | change | | 150° C., 30 minutes/ | |
| | | | | 1000 times (JIS C0027) | |
| THB test | No resistance | No | No resistance | 85° C./85% 3.6 V | Thermo- |
| | change | resistance | change | 1000 hr (JIS C0022) | hygrostat |
| | | change | | | |
| Sheet | 450 mΩ | 320 mΩ | 400 mΩ | 4-terminal sheet | Milliohm |
| Resistance | | | | resistance | Meter |
| | | | | measurement | |
| Hardness | 28 HVI | 36 HVI | 25~35 HVI | Advanced frictionless | Vickers |
| | | | | loading shaft | Hardness |
| | | | | mechanism | Tester HVS- |
| | | | | | 50 |
| | | | | | 5-2900 HVI |

### Experimental Embodiment 5

### Evaluation of Conductive Adhesive (for Filling a Through Hole)

After coating the adhesive of Comparative Example 4 and the adhesive of Embodiment 14 by a screen method using a metal mask on a printed circuit board (PCB), they were cured by using an oven. After that, viscosity, adhesive strength, sheet resistance, and hardness were measured. In addition, the existence of a resistance change was measured at a TC test, a THB test, a temperature-humidity bias test (THB), and so on. Table 4 shows test items and test results. With reference to Table 4, it can be seen that the adhesive of Embodiment 14 satisfied the requirements or had property similar or equivalent to the requirements in the viscosity, the adhesive strength, the sheet resistance, the hardness, the TC test, and the THB test. Particularly, the adhesive of Embodiment 14 had viscosity, adhesive strength, and hardness larger than those of the adhesive of Comparative Example 4.

TABLE 4

| | Comparative | Embodiment | | Measure | |
|---|---|---|---|---|---|
| Items | Example 4 | 14 | Requirement | method | Apparatus |
| Viscosity/ | 273 kcps/0.60 | 320 kcps/0.65 | 350 ± | 25° C., 10 rpm (JIS | Brookfield |
| thixo(T.I) | | | 50 kcps/0.6~0.7 | Z3284) | HBDV2 + pro |
| Adhesive | 15 N/mm² | 20 N/mm² | 15 N/mm² | KS M 3721 | 1605 HTP |
| Strength | | | | | (made by |
| | | | | | Aikoh) |
| TC test | No resistance | No | No resistance | 65° C., 30 minutes | T/C |
| | change | resistance | change | [symbol] 10 minutes [symbol] | apparatus |
| | | change | | 150° C., 30 minutes/ | |
| | | | | 1000 times (JIS C0027) | |
| THB test | No resistance | No | No resistance | 85° C./85% 3.6 V | Thermo- |
| | change | resistance | change | 1000 hr (JIS C0022) | hygrostat |
| | | change | | | |
| Sheet | 7 mΩ | 12 mΩ | 10 mΩ ± 3 | 4-terminal sheet | Milliohm |
| Resistance | | | | resistance | Meter |
| | | | | measurement | |
| | | | | (HIOKI 3541) | |
| Hardness | 55 HVI | 36 HVI | 45 HVI | Advanced frictionless | Vickers |
| | | | | loading shaft | Hardness |
| | | | | mechanism | Tester HVS- |
| | | | | | 50 |
| | | | | | 5-2900 HVI |
| Curing | 185° C./ | 185° C./ | 170° C./ | Heat wind, two-step | Oven |
| condition | 40 minutes | 40 minutes | 20 minutes | curing (1^{st}: 80° C., 2^{nd}: | |
| | | | | 185° C.) | |

### Experimental Embodiment 6

### Evaluation of Conductive Adhesive (for EMI)

Properties of the conductive adhesive manufactured by Embodiment 15 were evaluated. The viscosity was 400 Kcps (Brookfield, 25° C., 10 PPM), the thixotropic property was 6.8 cp, and the sheet resistance was 850 mΩ. Thus, the conductive adhesive of Embodiment 15 can be used for EMI.

### Experimental Embodiment 7

### Evaluation of Conductive Adhesive (for a PCB Stack Via)

After coating the adhesive of Comparative Example 3 and the adhesives of Embodiment 16 and 17 by a screen mounting apparatus having an opening of 150 μm on a stack substrate of a cellular phone, they were pre-cured for one minute at a temperature of 75° C. And then, they were coated in the same way five times, and were firstly-cured for 500 seconds (8 minutes and 20 seconds) at a temperature of 65° C. and were secondly-cured for 1000 seconds (16 minutes and 40 seconds) at a temperature of 165° C. After that, a PPG (an insulator that an epoxy resin is impregnated to a glass fiber) was coated, and two four-layered substrates were stacked to form an eight-layered double-sided substrate. The printed bump preheated for 80 minutes at 200° C. and laminated penetrated the PPG, and thus, electrodes were electrically connected. Thus, the eight-layered substrate was manufactured. After that, with respect to overall bumps and each bump, the existence of a resistance change was measured at a TC test (hot-cool circulation, −65° C. ˜150° C., 500 cycles), a temperature-humidity bias (THB) test (85° C., 85%, 500 hours), a reflow test (250° C.), and a soldering dipping test (STD) (260° C., 20 seconds, 5 times). Table 5 shows test items and test results. With reference to Table 5, it can be seen that the resistance of the adhesive of Embodiments 16 and 17 decreased at the results of the TC test, the THB test, the reflow test, and the SDT.

| | | Overall Bumps (mΩ) | | | Each Bump (mΩ) | | | |
|---|---|---|---|---|---|---|---|---|
| | | Embodi- | Embodi- | Comparative | Embodi- | Embodi- | Comparative | |
| Items | SPL | ment 16 | ment 17 | Example 3 | ment 16 | ment 17 | Example 3 | Note |
| THB | Initial | 963 | 175 | 2014 | 120 | 22 | 252 | After |
| | Resistance | | | | | | | 540 |
| | Resistance | 70 | 88 | 1954 | 9 | 11 | 244 | hours |
| | after | | | | | | | |
| | evaluation | | | | | | | |
| | Rate of | −92.70% | −49.80% | −3.00% | −92.5% | −50.0% | −3.17% | |
| | change | | | | | | | |
| TC | Initial | 413 | 175 | 1783 | 52 | 22 | 223 | After |
| | Resistance | | | | | | | 500 |
| | Resistance | 164 | 92 | 1751 | 20 | 12 | 219 | cycles |
| | after | | | | | | | |
| | evaluation | | | | | | | |
| | Rate of | −60.40% | −47.50% | −1.80% | −60.40% | −47.50% | −1.80% | |
| | change | | | | | | | |
| Re- | Initial | 374 | 177 | 2490 | 47 | 22 | 311 | 5 times |
| flow | Resistance | | | | | | | |
| (245° C.) | Resistance | 100 | 121 | 2905 | 13 | 15 | 288 | |
| | after | | | | | | | |
| | evaluation | | | | | | | |
| | Rate of | −73.40% | −31.80% | −7.40% | −73.40% | −31.80% | −7.40% | |
| | change | | | | | | | |
| Re- | Initial | 689 | 177 | 2225 | 86 | 22 | 278 | 3 times |
| flow | Resistance | | | | | | | |
| (260° C.) | Resistance | 129 | 102 | 2103 | 16 | 13 | 263 | |
| | after | | | | | | | |
| | evaluation | | | | | | | |
| | Rate of | −81.20% | −41.90% | −5.50% | −81.20% | −41.90% | −5.50% | |
| | change | | | | | | | |
| SDT | Initial | 404 | 162 | 2292 | 50 | 20 | 287 | 5 times |
| (260° C.) | Resistance | | | | | | | dipping |
| | Resistance | 103 | 125 | 2285 | 13 | 16 | 286 | (260° C.) |
| | after | | | | | | | |
| | evaluation | | | | | | | |
| | Rate of | −74.40% | −22.60% | −0.30% | −74.40% | −22.60% | −0.30% | |
| | change | | | | | | | |
| SDT | Initial | | 179 | 1893 | | 22.375 | 236.625 | 5 times |
| (288° C.) | Resistance | | | | | | | dipping |
| | Resistance | | 128 | 1657 | | 16 | 207.125 | (288° C.) |
| | after | | | | | | | |
| | evaluation | | | | | | | |
| | Rate of | | −28.20 | −12.50% | | −28.20 | −12.50 | |
| | change | | | | | | | |

In the above Embodiments, in the THB test, a substrate printed with a conductive ink was inserted into a thermo-hygrostat (85° C., 85% of humidity) and was maintained for 100 hours to 500 hours. The initial resistance and the resistance after the evaluation were measured. In the TC test, a thermal shock was applied to the substrate printed with the conductive ink by changing the temperature from a low temperature (−65° C.) to a high temperature (+150° C.) by 500 times. The initial resistance and the resistance after the evaluation were measured.

In the reflow test, the substrate printed with the conductive ink was inserted into a reflow oven, and was heated at temperature more than solder melting temperature (245° C. or 260° C.). The initial resistance and the resistance after the evaluation were measured.

In the SDT, the substrate printed with the conductive ink was enclosed with a heat-resisting tape, and was dipped into a solder solution of 260° C. or 288° C. The initial resistance and the resistance after the evaluation were measured.

Method for Manufacturing Conductive Adhesive

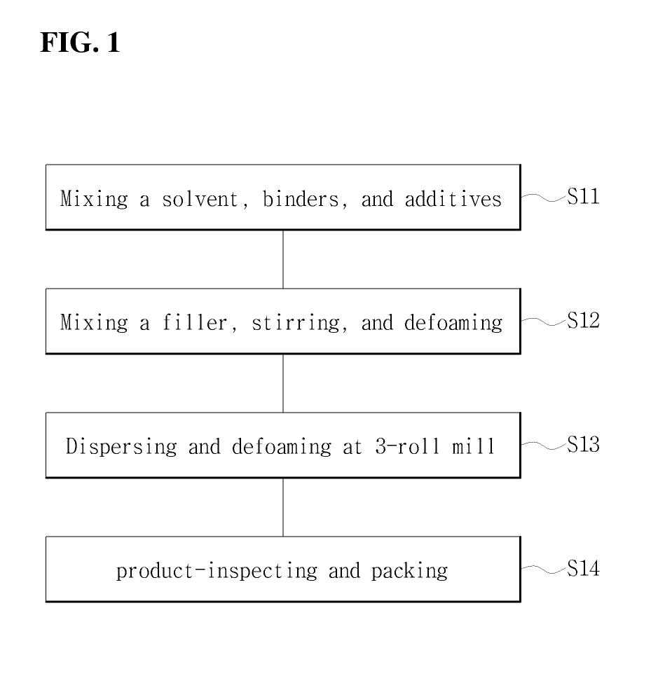

Hereinafter, with reference to FIG. 1, a method for manufacturing a conductive adhesive according to an embodiment of the present invention will be described in detail. FIG. 1 is a block diagram illustrating a method for manufacturing a conductive adhesive according to an embodiment of the present invention. With reference to FIG. 1, the method for manufacturing the conductive adhesive according to the embodiment of the present invention includes a step S11 of mixing a solvent, binders, and additives, a step S12 of mixing a filler, stiffing and defoaming, and a step S13 dispersing and defoaming the compound at a 3-roll mill, and a step S14 of product-inspecting and packing the manufactured conductive adhesive.

In the step S11, while a thermosetting resin and a rosin compound are dissolved into a solvent, and a modifier, a thixotropic agent, an active agent, a rust inhibitor and so on are added thereto, thereby forming an organic compound. After that, the temperature is decreased below a room temperature, and aging of the compound is performed. Particularly, since thermosetting resin and the rosin compound have a low toughness, the adhesive surface may be broken by a severe impact, and thus, components may be short-circuited. Thus, it is preferable to modify thermosetting resin and the rosin compound by adding at least one material of hydrogenated cast oil, siloxane-imide, liquid polybutadiene rubber, silica, and acrylate. In the step S12, the conductive particles, the low-melting alloy powder, and the nano powder are added as the filler, and they are mixed at a stirrer and deformed. In the step S13, the material mixed at the stirrer is dispersed at the 3-roll mill. Finally, in the step S14, the performance of the manufactured conductive adhesive is test, the product-inspecting is performed, and then the packing of the same is carried out.

In the method for manufacturing the conductive adhesive according to the embodiment of the present invention, the conductive particles may be metal powders, or particles including a core and a coating layer formed on a surface of the core. The conductive particles preferably have a size of about 0.05 μmm to about 10 μm.

The present invention is not limited to the method for forming the coating layer on the core. An electro plating method, an electoless plating method, or a vapor reaction method may be used. By the electroless plating method, the plating layer is dense, has a uniform thickness, and does not generate free metal. Also, the electroless plating method is cheap. Thus, the electroless plating may be preferable.

For example, the core may be copper and the coating layer may be silver. In this case, 99 wt % of the copper powder (99%, ChangSung) having a particle size of 5˜40 μm is prepared, and the copper powder is acid-cleaned by stiffing at H2SO4 having a concentration of 3M for 20 minutes in order to eliminate oxidized layers of the copper powders.

Next, the cleaned copper powders, silver nitrate (AgNo3), and an reducing agent (for example, hydroquinone [C6H4(OH)2] for reducing the silver nitrate are mixed, and thus, an aqueous solution of AgNo3 having pulp density of about 4˜16% is manufactured.

And then, the manufactured aqueous solution of AgNO3 and an aqueous solution of NH4OH are mixed with a ratio of 1:1, and are stirred for about 20 minutes.

After that, the reaction-completed powders are cleaned with distilled water and ethanol several times, and are dried about 24 hours at 60° C. Accordingly, the conductive particles are manufactured.

The low-melting alloy powder preferably has a particle size of about 0.05 μm to about 10 μm. At least one material of Sn/Bi, Sn/In, and Sn/Pb is used for the low-melting alloy powder. In the method for manufacturing the conductive adhesive according to the embodiment of the present invention, Sn42/Bi58 alloy powder may be used. At least one material selected from the group consisting of Ag, Cu, Al, Ni, expanded graphite, carbon nanotube (CNT), carbon, and graphene may be used as the nano powder. The naano powder preferably has a particle size of about 10 nm to 100 nm.

In the method for manufacturing the conductive adhesive according to the embodiment of the present invention, for thermosetting resin, at least one material selected from the group consisting of an epoxy resin, phenolics, a melamine resin, a urea resin, a polyester or unsaturated polyester resin, silicon, polyurethane, an allyl resin, a thermosetting acrylic resin, a condensation polymerized resin of phenol-melamine, and a condensation polymerized resin of urea-melamine may be used. Also, for the rosin compound, at least one material selected from the group consisting of gum rosin, rosin esters, polymerized rosin esters, hydrogenated rosin esters, disproportionated rosin esters, dibasic acid modified rosin esters, phenol modified rosin esters, a terpenephenolic copolymer resin, a maleic anhydride modified resin, and a hydrogenated acrylic modified resin may be used.

If necessary, the method for manufacturing the conductive adhesive according to the embodiment of the present invention may further include one or more steps adding a polyvalent alcohol-based solvent, a curing agent, an active agent, a rust inhibitor, a reducing agent, a thixotropic agent, a thickening agent, and so on, together or respectively.

Electronic Device

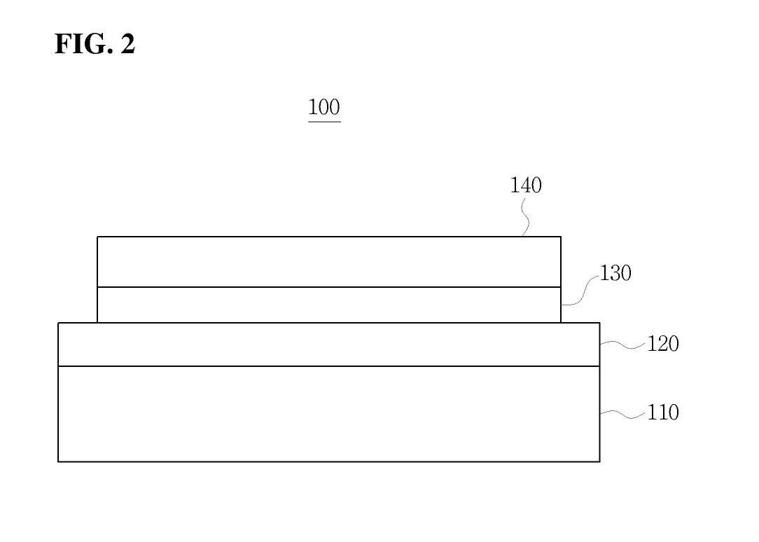

The conductive adhesive manufactured by the above method may be used for various electronic devices (for example, for bonding a semiconductor through hole, for forming an electrode of a plasma display panel, for forming a semiconductor device on an electrode, for forming a driving chip on a liquid crystal display, for forming an electrode of a solar cell, for replacing an indium-tin oxide (ITO) electrode, for boding for a circuit board, and so on). FIG. 2 is a sectional view illustrating a semiconductor device including a conductive adhesive according to an embodiment of the present invention. Referring to FIG. 2, a semiconductor apparatus 100 according to an embodiment of the present invention includes a substrate 110, and an electrode 120, a conductive adhesive 130, and a semiconductor device 140 formed on the substrate 110. In the semiconductor apparatus 100 according to the embodiment of the present invention, the conductive adhesive 130 adheres and electrically connects the electrode 120 and the semiconductor device 140 so that the semiconductor apparatus 100 can perform its function. The electrode 120 and the semiconductor device 140 can be adhered by coating the conductive adhesive 130 on a surface of the electrode 120 and curing the same. For the coating method, a screen printing method, a spray method, a dipping method, a dispensing method, and so on may be used. Although the semiconductor apparatus is illustrated in the above, the present invention is not limited thereto. Thus, the present invention includes various electronic devices having the conductive adhesive.

Although embodiments have been described with reference to a number of illustrative embodiments thereof, it should be understood that numerous other modifications and embodiments can be devised by those skilled in the art that will fall within the spirit and scope of the principles of this disclosure. Thus, above embodiments do not limit the present invention, and they should be regarded as examples for explain the present invention. Accordingly, the scope of the present invention is defined by following claims, and various variations and modifications within the scope of the present invention defined by the appended claims are included in the present invention.

1. A conductive adhesive, comprising:
a conductive particle;
a low-melting alloy powder comprising an alloy including Sn and at least one material selected from the group consisting of Ag, Cu, Bi, Zn, In, and Pb;
a nano powder;
a first binder comprising a thermosetting resin; and
a second binder comprising a rosin compound.

2. The conductive adhesive of claim 1, wherein the first binder comprises at least one material selected from the group consisting of an epoxy resin, phenolics, a melamine resin, a urea resin, a polyester or unsaturated polyester resin, silicon, polyurethane, a allyl resin, a thermosetting acrylic resin, a condensation polymerized resin of phenol-melamine, and a condensation polymerized resin of urea-melamine.

3. The conductive adhesive of claim 1, wherein the second binder comprises at least one material selected from the group consisting of gum rosin, rosin esters, polymerized rosin esters, hydrogenated rosin esters, disproportionated rosin esters, dibasic acid modified rosin esters, phenol modified rosin esters, a terpenephenolic copolymer resin, a maleic anhydride modified resin, and a hydrogenated acrylic modified resin.

4. The conductive adhesive of claim 1, further comprising a rust inhibitor,
wherein the rust inhibitor comprises an amine-based compound or an ammonium-based compound.

5. The conductive adhesive of claim 1, wherein the nano powder comprises at least one material selected from the group consisting of Ag, Cu, Al, Ni, expanded graphite, carbon nanotube (CNT), carbon, and graphene.

6. The conductive adhesive of claim 1, wherein the conductive adhesive comprises about 30˜85 wt % of the conductive particle, about 5˜50 wt % of the low-melting alloy powder, and about 3˜13 wt % of the nano powder.

7. The conductive adhesive of claim 1, wherein the size of the conductive particle is the same as or larger than that of the low-melting alloy powder, and the size of the low-melting allow particle is the same as or larger than that of the nano powder; or
the size of the low-melting allow particle is the same as or larger than the size of the conductive particle, and the size of the conductive particle is the same as or larger than that of the nano powder.

8. The conductive adhesive of claim 1, wherein the low-melting alloy powder comprises at least one material selected from the group consisting of a Sn—Bi based alloy, a Sn—In based alloy, a Sn—Pb based alloy, or a Sn—Ag—Cu based alloy.

9. The conductive adhesive of claim 8, wherein the low-melting alloy powder has a particle size of about 0.05 μmm to about 10 μm.

10. The conductive adhesive of claim 1, wherein the conductive particle comprises a metal powder.

11. The conductive adhesive of claim 10, wherein the metal powder consists of a copper powder.

12. The conductive adhesive of claim 1, wherein the conductive particle comprises a core, and a coating layer formed on a surface of the core.

13. The conductive adhesive of claim 12, wherein the core comprises a conductive core, and
the conductive core comprises at least one material selected from the group consisting of Cu, Ag, Au, Ni, and Al.

14. The conductive adhesive of claim 13, wherein the coating layer comprises at least one material selected from the group consisting of Cu, Ag, Au, Ni, Al, and solder, and
the at least one material is different from a material of the conductive core.

15. The conductive adhesive of claim 12, wherein the core comprises a non-conductive core, and
the non-conductive core comprises at least one material selected from the group consisting of glass, ceramic, a resin.

16. The conductive adhesive of claim 12, wherein the resin comprises at least one material selected from the group consisting of polyethylene, polypropylene, polystyrene, compolymer of methylmethacrylate-styrene, copolymer of acrylonitrile-styrene, acrylate, polyvinyl butyral, poly vinyl formal, polyimide, polyamide, polyester, polyvinyl chloride, a fluororesin, a urea resin, a melamine resin, a venzoguanamine resin, a phenol-formalin resin, a phenol resin, a xylene resin, a diarylphthalate resin, an epoxy resin, a polyisocyanate resin, a phenoxy resin, and a silicon resin.

17. The conductive adhesive of claim 15, wherein the coating layer comprises at least one material selected from the group consisting of Cu, Ag, Au, Ni, Al, and solder.

18. The conductive adhesive of claim 12, wherein the coating layer consists of at least one coating layer.

19. The conductive adhesive of claim 1, further comprising an active agent,
wherein the active agent comprises at least one material selected from the group consisting of a succinic acid, an adipic acid, a palmitic acid, a 3-boronfluoride ethyl amide complex, butylamine hydrobroimide, butylamine hydrochloride, ethylamine hydrobroimide, pyridine hydrobroimide, cyclohexylamine hydrobroimide, ethylamine hydrochloride, 1,3-diphenyl guanidine hydrobroimide, a 2,2-bishydroxymethyl propionic acid salt, 2,3-dibromo-1-propanol, a lauric acid, and memtetrahydrophthalic anhydride.

20. A method for manufacturing a conductive adhesive, comprising:
a step of modifying a thermosetting resin and a rosin compound by adding at least one material selected from the group consisting of hydrogenated cast oil, siloxane-imide, liquid polybutadiene rubber, silica, and acrylate into thermosetting resin and the rosin compound;
a step of forming a compound by mixing thermosetting resin and a conductive particle, a low-melting alloy powder, and nano powder, wherein the low-melting alloy powder comprising Sn, and at least one material selected from the group consisting of Ag, Cu, Bi, Zn, In, and Pb; and
a step of dispersing the compound.

21. The method of claim 20, wherein the conductive particle comprises a coating layer formed by an electroless plating method.

22. An electronic device, comprising:
a conductive particle;
a low-melting alloy powder comprises Sn and at least one material selected from the group consisting of Ag, Cu, Bi, Zn, In, and Pb;
a nano powder;
a first binder comprising a thermosetting resin; and
a second binder comprising a rosin compound.
